(19) United States
(12) Patent Application Publication
(10) Pub. No.: US 2004/0132840 A1
(43) Pub. Date: Jul. 8, 2004

(54) Methods for preparation of weak acid cation exchange resin, weak acid cation exchange resin, and down stream products made using the resins

(76) Inventors: James Charles Bohling, Lansdale, PA (US); Eric Gustave Lundquist, North Wales, PA (US)

Correspondence Address: ROHM AND HAAS COMPANY, PATENT DEPARTMENT, 100 INDEPENDENCE MALL WEST, PHILADELPHIA, PA, 19106-2399, US

(21) Appl. No.: 10/676,055

(22) Filed: Sep. 30, 2003

Related U.S. Application Data
(63) Continuation-in-part of application No. 09/873,806, filed on Jun. 4, 2001, now abandoned.

(51) Int. Cl. C08J 5/20

(52) U.S. Cl. 521/26

(57) ABSTRACT

The present invention provides a method and system of making a weak acid cation exchange resin. The method includes converting a swollen form weak acid cation exchange resin to a converted, unswollen form weak acid cation exchange resin, and steam cleaning the converted, unswollen form weak acid cation ion exchange resin to obtain a cleaned weak acid cation exchange resin in an unswollen form. Commercially valuable resins, products containing the resins, products made using the improved resins, and systems containing the resins are also provided herein. Exemplary products and systems include potable water purification systems and disposable cartridges.

This application claims priority to U.S. patent application Ser. No. 09/873,806, entitled “Preparation of Weak Acid Cation Exchange Resins,” (“'806 Application”), and any priority applications to which the '806 Application claims priority.

This invention relates to an improved process for the preparation of weak acid cation exchange resins, and methods and systems using the resins, and downstream products made using the resins. In particular, the present invention concerns the cleaning of weak acid cation exchange resins derived from crosslinked poly(acrylonitrile).

Weak acid cation exchange resins have found great utility in the removal of hardness ions (for example, calcium and magnesium) and certain metals (lead, mercury, copper, zinc) from drinking water. The high ion exchange capacity and selectivity of weak acid cation exchange resins are ideal properties in this application. As such, the combination of weak acid cation exchange resins with activated carbon in mixed-bed systems has found widespread use in potable water treatment applications, such as water-pitcher filter applications for drinking water. It is desirable that the weak acid cation exchange resins should not release any extractable materials from the resin into the treated water. These extractable materials are typically byproducts from the ion exchange manufacturing process.

Thus, the cleaning of weak acid cation exchange resins to remove extractables (such as uncrosslinked polymer chains, initiator residues and other contaminants) is desired to obtain acceptable performance in many end-use applications. Without proper cleaning the resins may release materials into the treated water, resulting in foaming, color throw, odor, high TOC (total organic carbon) values and other undesirable effects.

When adsorbents, such as activated carbon, are used in conjunction with weak acid cation exchange resins to remove organic materials (such as trihalomethanes or THM) from drinking water, we have found that materials released from the weak acid cation exchange resin become adsorbed onto the surface of the activated carbon, consequently fouling the surface and pores of the carbon and consequently reducing the ability of the carbon to efficiently remove THM from the drinking water.

Weak acid cation exchange resins are typically manufactured by the suspension polymerization of hydrolyzable acrylic monomers (such as acrylonitrile, methyl acrylate and other acrylate esters) with a suitable crosslinking monomer (such as divinylbenzene (DVB), trivinylcyclohexane (TVCH), 1,7-octadiene or diethyleneglycol divinylether). These crosslinked copolymers are then hydrolyzed either under acidic or basic conditions to provide the corresponding polycarboxylic acid products.

Both acid-catalyzed and base-catalyzed hydrolyses of crosslinked poly(acrylonitrile) bead polymer present problems that must be addressed during the manufacturing process for weak acid cation exchange resins. For example, acid hydrolysis (sulfuric acid) typically proceeds with the vigorous evolution of heat, making the hydrolysis difficult to control on an industrial scale; in addition, large quantities of waste sulfuric acid are generated during the hydrolysis. The waste sulfuric acid is further contaminated by salts (ammonium sulfate) resulting from in-process neutralization of ammonia during hydrolysis, requiring further time-consuming efforts to process materials for disposal or re-use.

Alkaline (basic) hydrolysis is typically performed by contacting the crosslinked poly(acrylonitrile) bead polymer with aqueous, alcoholic or mixed aqueous-alcoholic alkali metal hydroxide solutions at elevated temperatures under reflux or in closed pressure vessels (autoclaves) until hydrolysis is complete. The generation of ammonia results in safety concerns similar to those discussed for the acid hydrolysis reaction: vigorous evolution of heat, plus the sporadic generation of gaseous ammonia during hydrolysis.

Similarly, acid-catalyzed and base-catalyzed hydrolyses of crosslinked poly(alkyl acrylate) materials generate waste streams and byproduct contaminants during the manufacturing process of weak acid cation exchange resins, for example, volatile (C₁-C₄)alcohols and corresponding ether compounds resulting from condensation of the alcohols.

In addition to the aforementioned safety and environmental issues inherent in the manufacturing process, the resultant weak acid cation exchange resin intermediates must be extensively cleaned to remove byproducts generated during the manufacturing process. Such cleaning steps are mandated to ensure the quality of the weak acid cation exchange resin materials used in treatment systems for drinking water applications. Previous efforts (U.S. Pat. Nos. 3,544,488 and 3,687,912) to minimize the amount of byproducts in hydrolyzed poly(acrylonitrile) resins include the use of selected co-crosslinking agents (in addition to DVB). U.S. Pat. No. 5,175,193 discloses the alkaline hydrolysis of crosslinked poly(acrylonitrile) where the alkaline hydrolyzing agent and the crosslinked poly(acrylonitrile) are brought together only at elevated temperatures, that is, greater than 105° C. However, resins from the above treatments still require extensive cleaning before they may be used in typical drinking water applications.

Previous methods used in the prior art are conceptually distinguishable from the present invention. By way of example, U.S. patent application Ser. No. 5,900,146 (“'146 Patent”) generally relates to manufacture of an acrylic strong anion exchanger which swells. The acrylic strong anion exchanger is washed with HCl in its swollen state to remove residual reagent, and washed with ethanol in its swollen state. None of the examples in the '146 Patent steam clean a cation ion exchange resin in its protonated, unswollen form. By way of further example, U.S. patent application Ser. No. 4,245,053 (“'053 Patent”) generally relates to regenerating spent resins, and not making new resins. The spent beads of the '053 Patent are swollen beads. None of the examples in the '053 Patent steam clean a cation ion exchanger in its protonated, unswollen form. By way of yet further example, U.S. patent application Ser. No. 5,954,965 (“'965 Patent”) generally relates to producing pure water. The spent beads of the '965 Patent are swollen beads. None of the examples in the '965 Patent steam clean a cation ion exchange resin in its protonated, unswollen form. A further disadvantage of the '965 patent involves an inability to ship products disinfected and imbibed with an alcohol because a fire hazard is created, and once the alcohol evaporates there is no more anti-bacterial effect on the resin.

The problem addressed by the present invention is to overcome the deficiencies of prior methods used to reduce the presence of contaminants from the manufacturing process in the final weak acid cation exchange resin.

The present invention provides a process for cleaning weak acid cation exchange resins comprising (a) converting a weak acid cation exchange resin, substantially in neutralized salt form, to a hydrogen-form weak acid cation exchange resin by regenerating with an acid regenerant; and (b) contacting the hydrogen-form weak acid cation exchange resin with 1 to 15 kilograms of steam per kilogram of hydrogen-form weak acid cation exchange resin at a resin bed temperature of 100 to 180° C. for a period of at least one hour.

In another embodiment the present invention provides a method for treating water for use as drinking water comprising contacting water to be treated with a bed of weak-acid cation exchange resin that has been cleaned by the aforementioned process.

In a further embodiment the present invention provides the aformentioned process in which the weak acid cation exchange resin is selected from one or more copolymers of crosslinked poly(acrylic acid), crosslinked poly(methacrylic acid), hydrolyzed crosslinked poly((C₁-C₄)alkyl acrylate) and hydrolyzed crosslinked poly(acrylonitrile).

The conventional process for cleaning resins is to put then into their maximum expanded, swollen state, in the sodium form. Placing the resin in its sodium form increases swelling. This loosens up the polymer matrix and gives contaminants, e.g. initiator byproducts and oligomers, room to transport out of the bead through the polymer matrix or net. When the polymer is in its uncontracted form, e.g. swollen form, these contaminants freely can move out of the bead. For maximum cleaning one would be motivated to conduct all cleaning procedures with the resin in its swollen form.

Contrary to the conventional process and conceptually distinguishable therefrom, it has been determined unexpectedly that for weak acid cation resins it is preferable to steam clean the resin in the protonated and contracted, e.g. unswollen form. Given conventional wisdom, one would expect that since the polymer matrix is contracted, contaminants would be retained within the matrix, and would not be able to freely move out of a tighter matrix. Therefore, given conventional wisdom, it would not be desireable to conduct any cleaning procedures with the resin beads in their contracted, unswollen form.

We have discovered an improved process for effectively cleaning weak acid cation exchange resin intermediates that results in finished weak acid cation exchange resins that provide improved performance of water-treatment systems by steam cleaning the resin in its unswollen, protonated form. The process of the present invention is applicable to weak acid cation exchange resins derived from either acidic or basic hydrolyses of crosslinked polycarboxylate resin precursors. We have found that selected steam treatment at a specified point in the processing of the weak acid cation exchange resin provides a final weak acid cation exchange resin useful as a component in potable water treatment systems, such as cartridge-water-pitcher systems having enhanced THM removal efficiency.

The invention provides for a method of making a weak acid cation exchange resin. The method includes converting a swollen form weak acid cation exchange resin to a converted, unswollen form weak acid cation exchange resin, and steam cleaning the converted, unswollen form weak acid cation ion exchange resin to obtain a cleaned weak acid cation exchange resin in an unswollen form. By way of example, the unswollen weak acid cation exchange resin is selected from one or more copolymers of crosslinked poly(acrylic acid), crosslinked poly(methacrylic acid), hydrolyzed crosslinked poly((C₁-C₄)alkyl acrylate) and hydrolyzed crosslinked poly(acrylonitrile).

In one variant, the converted, unswollen, weak acid cation exchange resin is contacted with 2 to 5 kilograms of steam per kilogram of hydrogen-form weak acid cation exchange resin, and/or contacted with steam for 2 to 4 hours. Optionally, the converted, unswollen weak acid cation exchange resin is contacted with one or more of peroxides.

It is appreciated that a resin made by the method described above has superior performance characteristics to resins that are steam treated in their swollen form. These resins can be used in various industrial systems. Exemplary, systems include a disposable water treatment cartridge (which can optionally include a jug and filter), household water treatment systems, a pharmaceutical purification system, a chromatographic system, an industrial water treatment system, and a catalytic system comprising one or more resin catalysts. Various downstream products are also made using the cleaned resin described herein. It is appreciated that the processes for making downstream products improve the ultimate products created. Exemplary downstream products include a pharmaceutical ingredient, a pharmaceutical excipient, and a high purity water.

As used herein, the following terms have the designated definitions, unless the context clearly indicates otherwise. The term “crosslinked polycarboxylate resin precursor” will refer to any polymer capable of providing a weak acid cation exchange resin either by direct copolymerization of acrylic acid or methacrylic acid monomers with crosslinking monomers or by copolymerization of acid-precursor monomers (such as acrylonitrile or (C₁-C₄)alkyl acrylates) that are subsequently hydrolyzable to carboxylic acid groups. The term “copolymer” refers to polymer compositions containing units of two or more different monomers, including positional isomers. THM is used as an acronym for “trihalomethanes” (which include chloroform, bromodichloromethane, dibromochloromethane and bromoform, for example); the removal of chloroform from fluid streams in various test methods is typically used as an indication of THM removal efficiency of water treatment systems containing weak acid cation exchange resins as one component.

The following abbreviations are used herein: WAC=weak acid cation exchange resin; g=grams; kg=kilograms; L=liters; ml=milliliters; cm=centimeter; ppb=parts per billion by weight/volume; pressure is in kiloPascals (kPa). Unless otherwise specified, ranges listed are to be read as inclusive and combinable, temperatures are in degrees centigrade (° C.), and references to percentages (%) are by weight.

The process of the present invention is useful for treatment of WAC produced by a variety of manufacturing processes. Suitable weak acid cation exchange resins include, for example, those derived from crosslinked poly(acrylic acid), crosslinked poly(methacrylic acid), hydrolyzed crosslinked poly((C₁-C₄)-alkyl acrylate) and hydrolyzed crosslinked poly(acrylonitrile); it is understood that these polymers may be copolymers comprising one or more of acrylic acid, methacrylic acid, (C₁-C₄)alkyl acrylate and acrylonitrile monomer units in polymerized form. Suitable crosslinking agents useful in preparing the aforementioned crosslinked polymers include, for example, aromatic polyvinyl compounds (such as divinylbenzene, trivinylbenzene, divinyltoluene, divinylpyridine, divinylnaphthalene and divinylxylene) and non-aromatic crosslinking monomers (such as ethyleneglycol diacrylate, ethyleneglycol dimethacrylate, trimethylolpropane triacrylate, trimethylolpropane trimethacrylate, diethyleneglycol divinyl ether, 1,5-hexadiene, 2,5-dimethyl-1,5-hexadiene, 1,7-octadiene, trivinylcyclohexane and triallyl isocyanurate). Preferably, the crosslinkers are selected from one or more of divinylbenzene (DVB), trivinylcyclohexane (TVCH), 1,7-octadiene and diethyleneglycol divinylether. Typically, the crosslinked polycarboxylate resin precursor contains 0.5 to 40%, preferably 1 to 25%, more preferably 2 to 20% and most preferably 3 to 15%, of crosslinker, based on weight of crosslinker in the polycarboxylate resin precursor prior to hydrolysis to the carboxylate form. For example, crosslinked poly(methyl acrylate) or crosslinked poly(acrylonitrile) precursors would be subjected to acidic or basic hydrolysis to provide the corresponding crosslinked poly(acrylic acid) weak acid cation exchange resins.

Although detailed descriptions of the hydrolysis of crosslinked poly(acrylonitrile) or poly(acrylate) substrates to provide the corresponding weak acid cation exchange resins are available, little attention has been directed to the washing conditions used after hydrolysis and just prior to providing the WAC resin in its finished form. For example, post-hydrolysis treatments are typically characterized by washing of the caustic-hydrolyzed crosslinked poly(acrylo-nitrile) intermediate, conversion to hydrogen-form with excess acid and washing until neutral (U.S. Pat. Nos. 3,544,488, 3,687,912 and 5,175,193). Similarly, post-hydrolysis treatment of caustic hydrolyzed crosslinked poly(acrylate) intermediates is characterized by washing with 1N hydrochloric acid (U.S. Pat. No. 4,614,751).

The process of the present invention involves starting with a WAC substantially in the neutralized salt-form, that is, where at least about 90% of the carboxylic acid functionality is in the salt form. Suitable neutralized salt forms include, for example, sodium, potassium, lithium and ammonium salts; preferably the WAC is provided in the sodium-form. The neutralized salt-form WAC may be provided directly from an alkaline hydrolysis reaction of a crosslinked polycarboxylate resin precursor, by conversion of the hydrogen-form WAC (such as from the acidic hydrolysis of a crosslinked polycarboxylate resin precursor) to the neutralized salt-form by conventional regeneration methods (see below), or by conventional regeneration of any available hydrogen-form WAC to the neutralized salt-form. The neutralized salt-form WAC may be converted to the hydrogen-form (as described below) or optionally backwashed first, or further washed with additional water (ambient temperature up to about 90° C.), prior to conversion to the hydrogen-form. Preferably, the neutralized salt-form WAC is washed (backflow or downflow) with water at 60-90° C. prior to conversion to the hydrogen-form.

The acid regenerant useful in converting the neutralized salt-form WAC to the hydrogen-form WAC can be any strong acid, such as mineral acid, for example, sulfuric acid, hydrochloric acid, phosphoric acid or nitric acid. Preferably, the acid regenerant is selected from one or more of sulfuric acid and hydrochloric acid. Typically, regeneration is conducted by contacting (downflow or upflow column treatment) the WAC with an excess of acid regenerant, generally from 2 to 4 molar equivalents of acid regenerant per equivalent of WAC. The acid regenerant solution is typically a dilute aqueous solution of the acid, such as 0.5 to 20% acid, preferably from 1 to 15% and more preferably from 2 to 10%, based on weight of the aqueous solution.

Alternatively, the neutralized salt-form WAC may be converted to the hydrogen-form WAC by regeneration with any weak acid having a pKa between 3 and 7, preferably between 4 and 7, and more preferably between 4 and 6.5. Suitable weak acid regenerants include, for example, carbonic acid and carboxylic acids such as acetic acid, citric acid, maleic acid, lactic acid and mixtures thereof; when used, the weak acid regenerant is preferably selected from one or more of citric acid and carbonic acid.

Typical regeneration (conversion from hydrogen-form to sodium-form versions, and vice versa) of the WAC involves treatment with the appropriate reagents, typically at temperatures from ambient (room) temperature up to about 90° C., at flow rates of about 1 bed volume (BV), typically up to 10 BV, of regenerant per hour. For example, conversion of a hydrogen-form WAC to the sodium-form and back into the hydrogen-form would typically involve the following sequence: four bed volumes of 7% aqueous sodium hydroxide solution, two bed volumes of water, four bed volumes of 7% aqueous hydrochloric acid solution, and two bed volumes of water.

The hydrogen-form resin is then steam treated at a resin bed temperature of 100 to 180° C., preferably from 110 to 150° C. and more preferably from 120 to is 140° C., for at least 1 hour (typically 1 to 15 hours, preferably 1 to 10 hours and more preferably 2 to 4 hours) in the hydrogen-form to provide a WAC suitable for use in drinking water-treatment systems. Typically at least 1 kg steam, preferably from 1 to 15 kg, more preferably from 2 to 10 kg and most preferably from 2 to 5 kg, is used per kg WAC. The steam treatment may be conducted conveniently by pressurized steam injection into a bed of WAC or by external heating of a wash column containing WAC; typically pressurized steam injection is used at pressures of 0.1-7×10³ kPa (1 to 1000 pounds per square inch gauge, psig), preferably 0.17-3.5×10³ kPa (10 to 500 psig) and more preferably 2.4-7×10² kPa (20 to 100 psig). The steam treatment may be conducted by contacting the hydrogen-form WAC with steam by upflow, downflow (typically in columns) or in a batch mode (such as pressure kettle). Typically, the hydrogen-form WAC is isolated by draining the steam-treated resin free of residual surface water, followed by pack out.

If the steam treatment is conducted below about 100° C. or the contact time of the treatment is less than about 1 hour, the quality of the final resin as measured by the efficiency of THM removal by mixed-bed systems containing the WAC is unsatisfactory. For example, if only a hot-water wash (temperature of 80 to 90° C.) is used to treat the hydrogen-form WAC, the WAC will contain undesirable residual extractable materials that contribute odor to the treated resin.

After steam-treatment and before final packout of the WAC, additional optional treatments may be applied to the WAC. For example, steam-treated WAC may be given a final dilute acid-wash to remove low levels of any basic contaminants from the processing steps, comprising contacting the hydrogen-form WAC in a downflow mode with 2 to 5 bed-volumes of dilute acid (such as aqueous solutions of 0.05-1N sulfuric acid, hydrochloric acid, phosphoric acid or nitric acid) and then rinsing the hydrogen-form WAC with water prior to final packout. Preferably, the optional acid-wash involves using 0.1N sulfuric acid.

Other optional treatments prior to final packout of the finished WAC include, for example, backwashing to remove fines (small-sized resin particle contaminants), and treatment to minimize antimicrobial growth in the finished resin. For example, steam-treated WAC may be given an antimicrobial treatment comprising contacting the hydrogen-form WAC with 0.4 to 5 g, preferably 0.5 to 3 g and more preferably 0.7 to 2 g, of an antimicrobial agent per kg of hydrogen-form WAC prior to final packout. Typically, the optional antimicrobial treatment involves use of an antimicrobial agent selected from one or more of peroxides, (C₂-C₃)alcohols, and inorganic chloride salts. Suitable peroxides include, for example, hydrogen peroxide and peracetic acid; suitable alchohols include, for example, ethanol and isopropanol; suitable inorganic chloride salts include, for example, sodium chloride and potassium chloride. Preferably, when peroxides are used in the antimicrobial treatment, the level used is from 0.5 to 1.5 g peroxide per kg WAC.

We have found that it is desirable to conduct the steam treatment step on the WAC in the hydrogen-form. If the steam treatment is conducted on the sodium-form of the WAC, followed by conversion to the hydrogen-form WAC (without any steam-treatment of the hydrogen-form resin), the desired beneficial results are not achieved.

Typically, WAC are washed free of any contaminants in the sodium-form because the ionized (neutralized) form of the carboxylic acid functionality is more fully hydrated than the less ionized hydrogen (un-neutralized) form and the neutralized form is considered to have a more swollen, open molecular structure, thus facilitating transport of undesirable materials out of the crosslinked polymer matrix. Thus, we unexpectedly found that WAC treated by the process of the present invention, that is, steam treatment step on the WAC in the hydrogen-form, provided a “cleaner” final form WAC as evidenced by enhanced THM removal of cartridge-type water treatment systems containing the WAC resin as part of a mixed-bed system. In contrast, WAC treated in the conventional manner, that is, steam treatment step of the WAC in the sodium-form, resulted in less efficient THM removal of cartridge-type water treatment systems. Steam treatment in the hydrogen-form further provides an economic benefit by allowing a greater quantity of WAC to be treated per treatment step (typically in 1000-L wash columns) due to the greater density of the hydrogen (free acid) form of the resin relative the sodium (neutralized) form.

The effectiveness of the process of the present invention was demonstrated by evaluating the efficiency of the WAC (subjected to the process of the present invention) for removing THM (using chloroform as a representative THM material) from contaminated water using a mixed bed of treated WAC resin plus activated carbon in a “pitcher-type drinking water filter” arrangement, such as described in U.S. Pat. Nos. 4,895,648, 4,969,996 and 6,012,232.

Table 1 summarizes the results of THM removal efficiency using WAC resins treated by the process of the present invention and WAC resins conditioned by various other routes.

Resin 1 (comparative) is representative of a commercially available WAC provided in the hydrogen-form (Bayer Lewatit™ CNP resin)

Resin 2 (comparative) is representative of a comparative treatment where the WAC derived from acidic hydrolysis (hydrogen-form) was subjected to steam treatment in the hydrogen form (see conditions described in Example 1). This resin did not undergo a conversion to the sodium-form during its processing.

Resin 3 (comparative) is representative of a comparative treatment where the WAC derived from acidic hydrolysis (hydrogen-form) was converted to the sodium-form followed by steam treatment (see conditions described in Example 1) in the sodium form. The resin was then regenerated to hydrogen-form prior to THM efficiency evaluation. This resin did not undergo a steam-treatment while in hydrogen-form.

Resin 4 is representative of a treatment by the process of the present invention where the WAC (hydrogen-form) derived from acidic hydrolysis was first regenerated to the sodium-form, followed by regeneration back to the hydrogen-form, and finally subjected to steam treatment in the hydrogen-form.

For each of the resins Table 1, the results represent an average of 3 separate chloroform removal evaluations involving 3 different lots of each resin.

TABLE 1

Percent Chloroform Removed

| Liters (L) of | Resin 1 | Resin 2 | Resin 3 | |
|---|---|---|---|---|
| Water Treated | (comp) | (comp) | (comp) | Resin 4 |
| 4 | 84 | 79 | 80 | 84 |
| 8 | 77 | 77 | 80 | 84 |
| 12 | 79 | 74 | 79 | 81 |
| 16 | 76 | 69 | 79 | 80 |
| average | 79 | 75 | 79 | 82 |
| (1-16 L) | | | | |
| Δ* | −3 | −7 | −3 | — |
| 20 | 70 | 72 | 75 | 77 |
| 24 | 68 | 68 | 72 | 76 |
| 28 | 72 | 66 | 72 | 78 |
| 32 | 67 | 65 | 70 | 72 |
| average | 69 | 68 | 72 | 76 |
| (17-32 L) | | | | |
| Δ* | −7 | −8 | −4 | — |
| average | 74 | 71 | 76 | 79 |
| (1-32 L) | | | | |
| Δ* | −5 | −8 | −3 | — |

*= difference between comparative Resins 1, 2 or 3 and Resin 4 “% chloroform removal” value = [Resin 1, 2, or 3] − [Resin 4] = Δ

Applicants put the resin of the present invention (resin 4) in an actual application, and found that the resin performed significantly better than resins steam cleaned in a swollen form (resins 1-3). The improvement in efficiency of THM removal for water-treatment systems containing WAC treated by the process of the present invention was demonstrated by comparing “% chloroform removed” values for Resin 4 in Table 1 to the comparative Resins 1, 2 and 3. For example, for the first 16 liters of treated water, Resin 4 provided an additional 3-7% in chloroform removal efficiency versus comparative Resins 1, 2 and 3. For the next 16 liters of treated water, Resin 4 retained its chloroform removal efficiency to a greater degree than did Resins 1, 2 and 3, by providing an additional 4-8% improvement in efficiency. Overall, for 32 liters of treated water, Resin 4 provided an additional 3-8% in chloroform removal efficiency relative to the performance of comparative Resins 1, 2 and 3.

Another benefit of the present invention relates to the amount of resin that can be placed into a steam cleaning column. For example, resins in the sodium form will swell 50-100% in the sodium form. Resins in the hydrogen form are smaller since they are contracted. This means that significantly more resin fits into a steam cleaning column than resin in a swollen form meaning more resin can be steam cleaned in a given column and higher throughput can also be obtained for steam treatment columns vs. resins in the swollen form.

Various examples of the invention are described in the following Examples. All ratios, parts and percentages are expressed by weight unless otherwise specified, and all reagents used are of good commercial quality unless otherwise specified. Abbreviations used in the Examples and Tables are listed below:

| | |
|---|---|
| BV = | Bed Volume (volume of ion exchange resin bed, including |
| | interstitial water) |
| WAC = | Weak Acid Cation Exchange Resin |
| THM = | Trihalomethanes (chloroform) |
| GAC = | Granulated Activated Carbon |
| meq/g = | Milliequivalents per Gram |
| meq/ml = | Milliequivalents per Milliliter |

### EXAMPLE 1

The WAC used a starting material in the evaluation of Resins 2, 3 and 4 (Table 1) were based on a resin derived from acid hydrolysis of a suspension polymer of crosslinked poly(acrylonitrile) containing 6% non-aromatic crosslinker. The resultant hydrogen-form WAC had a moisture holding capacity of 55% and a cation exchange capacity of 11.0 meq/g (4.0 meq/ml). The WAC corresponding to Resin 1 (Table 1) was a commercial hydrogen-form WAC (Bayer Lewatit™ CNP resin having a moisture holding capacity of 50% and a cation exchange capacity of 10.5 meq/g (4.2 meq/ml).

The hydrogen-from WAC were converted to the neutralized sodium-form by the following procedure. A sample (typically 0.1-0.5 liters) of hydrogen-form WAC was placed in an appropriately sized wash column (typically 2-5 cm internal diameter) and washed in a down flow manner with 4 BV of 7% aqueous sodium hydroxide solution at a flow rate of approximately 1-2 BV/hour. The resin bed was then rinsed with deionized water until excess sodium hydroxide regenerant had been removed (pH of the effluent rinse water less than about 9, preferably less than 8.5).

The sodium-form WAC was then converted to the free-acid hydrogen-form by the following procedure. A sample of sodium-form WAC was washed in a down flow manner (similar arrangement described above) with 7 BV of 7% aqueous sulfuric acid solution over 1 hour. The resin bed was then rinsed with deionized water until excess sulfuric acid regenerant had been removed (pH of the effluent rinse water greater than about 4, preferably greater than 4.5).

### EXAMPLE 2

With the WAC in the hydrogen-from, the resins are subjected to steam treatment according to the following procedure. Hydrogen-form WAC is down flow steam-treated at 125-135° C. for 4 hours using at 100-1000 g, typically 400-800 g, steam per 100 g resin. The steam-treated resin is then backwashed for approximately 2 hours with deionized water until free of visible fine particles and then finally washed down flow for 2 hours using 600 ml deionized water per 100 g resin.

### EXAMPLE 3

THM removal efficiency of WAC resins was determined by using a water-pitcher drinking water filter simulation and measuring the percentage of THM (chloroform) removed per volume of water treated with cartridges containing a mixed bed of weak acid cation resin (prepared as described in Example 1) and granular activated carbon (GAC). A common source of GAC was used throughout to make up the mixed resin beds for evaluation. This method directly relates to the effectiveness of a pitcher-type drinking water filter's ability to remove THMs.

Challenge (“contaminated”) water was prepared as follows. Into a clean, covered 20-liter plastic pail was placed 2.02 g CaCl₂.2H₂O, 0.48 g MgSO₄.6H₂O, 2.69 g NaHCO₃ and 16-liters of deionized water. THM stock solution (approximately 1-ml of 1% chloroform in methanol) calibrated to deliver approximately 250-400 ppb chloroform was then added and the mixture stirred for 10 minutes. The solution was promptly transferred into four 4-liter amber bottles and sealed with Teflon™ lined caps. The challenge-water was used within 24 hours of preparation.

The mixed-bed cartridges were prepared by placing 90 ml of WAC into a pitcher, adding 30 ml of GAC and swirling until mixed (usually less than 30 seconds) and then pouring this mixture into an empty cylinder cartridge (95 mm body length, 45-50 mm diameter, 32 mm cap length). The cartridge was sealed with an end-cover (lid) and placed into a 600-ml beaker and tap water was added up to the shoulder of the cartridge. The cartridge was soaked for 15 minutes and then placed into a filter pitcher with cover. One liter of tap water was poured through the cartridge and allowed to drain (elute) through the cartridge to remove color contaminants (fines) from the GAC—some initial dark water was normal and was typically eluted in the first BV (about 100 ml)—the water was clear by the end of the one liter elution and the elution water was discarded. The rinsed cartridge was then subjected to the test procedure.

The test cartridge was placed in a Millipore™ filter body housing and connected to a 1-liter water-pitcher top via Teflon tubing. A pump situated between the test cartridge and the water-pitcher (Brita™ pitcher bottom) was used to produce treated water effluent at a constant flow rate. Challenge-water (containing approximately 250-400 ppb THM, as chloroform) was added to the filter-body housing and the pump was started to deliver “treated” challenge-water to the water-pitcher. The water-pitcher was emptied after every 1-2 liters of treated water had been delivered. A sample for THM analysis was then taken after 4 liters of treated water had been delivered to the water-pitcher. Typically a total of at least 32 liters of treated water was generated with samples taken every 4 to 8 liters. THM analyses were provided by Lancaster Laboratories (Lancaster, Pa., USA) using EPA (Environmental Protection Agency) Test Method 502.2 for residual chloroform. Analytical samples using Lancaster Laboratory sample vials with pre-formulated preservative ascorbic acid/HCl solution were refrigerated prior to analysis and analyses were conducted within 24-48 hours of sampling.

Results from representative individual THM removal evaluations of WAC treated by a comparative treatment and the process of the present invention (Resins 3 and 4 in Table 1) are summarized in Tables 2 and 3, respectively. Additional results, including comparative treatments, are presented in Table 1.

TABLE 2
(Resin 3)

| | | THM | THM | |
|---|---|---|---|---|
| Sample | Total Effluent | Concentration | Concentration | % THM |
| # | Water Treated (L) | (ppb) Feed | (ppb) Effluent | Removed* |
| 1 | 4 | 250 | 61 | 76 |
| 2 | 8 | 280 | 74 | 74 |
| 3 | 12 | 260 | 47 | 82 |
| 4 | 16 | 250 | 65 | 74 |
| 5 | 20 | 240 | 61 | 75 |
| 6 | 24 | 280 | 85 | 70 |
| 7 | 28 | 370 | 110 | 70 |
| 8 | 32 | 350 | 110 | 69 |

*= [(Feed − Effluent)/(Feed)] × 100

TABLE 3
(Resin 4)

| | | THM | THM | |
|---|---|---|---|---|
| Sample | Total Effluent | Concentration | Concentration | % THM |
| # | Water Treated (L) | (ppb) Feed | (ppb) Effluent | Removed* |
| 1 | 4 | 250 | 43 | 83 |
| 2 | 8 | 280 | 57 | 80 |
| 3 | 12 | 260 | 41 | 84 |
| 4 | 16 | 250 | 53 | 79 |
| 5 | 20 | 240 | 55 | 77 |
| 6 | 24 | 280 | 66 | 76 |
| 7 | 28 | 370 | 82 | 78 |
| 8 | 32 | 350 | 100 | 71 |

*= [(Feed − Effluent)/(Feed)] × 100

In yet other variants of the invention, a process for cleaning weak acid cation exchange resins is provided. The process includes (a) converting a weak acid cation exchange resin, substantially in neutralized salt form, to a hydrogen-form weak acid cation exchange resin by regenerating with an acid regenerant; and (b) contacting the hydrogen-form weak acid cation exchange resin with 1 to 15 kilograms of steam per kilogram of hydrogen-form weak acid cation exchange resin at a resin bed temperature of 100 to 180° C. for a period of at least one hour.

Optionally, one or more of the following steps can be practiced: the acid regenerant in step (a) is selected from one or more of 1 to 15 percent aqueous solutions of sulfuric acid and hydrochloric acid, step (b) is conducted at a resin bed temperature of 120 to 140° C., the hydrogen-form weak acid cation exchange resin in step (b) is contacted with 2 to 5 kilograms of steam per kilogram of hydrogen-form weak acid cation exchange resin, and/or the hydrogen-form weak acid cation exchange resin in step (b) is contacted with steam for 2 to 4 hours.

In yet another variant, the process includes contacting the hydrogen-form weak acid cation exchange resin from step (b) with 2 to 5 bed-volumes of dilute acid and then rinsing the hydrogen-form weak acid cation exchange resin with water. The dilute acid is selected from one or more of 0.05 to 1 N aqueous solution of sulfuric acid, hydrochloric acid and phosphoric acid.

In yet a further variant, the present invention provides a method for treating water for use as drinking water comprising contacting water to be treated with a bed of weak-acid cation exchange resin that has been cleaned by (a) converting the weak acid cation exchange resin, substantially in neutralized salt form, to a hydrogen-form weak acid cation exchange resin by regenerating with an acid regenerant; and (b) contacting the hydrogen-form weak acid cation exchange resin with 1 to 15 kilograms of steam per kilogram of hydrogen-form weak acid cation exchange resin at a resin bed temperature of 100 to 180° C. for a period of at least one hour.

While only a few, preferred embodiments of the invention have been described hereinabove, those of ordinary skill in the art will recognize that the embodiment may be modified and altered without departing from the central spirit and scope of the invention. Thus, the preferred embodiment described hereinabove is to be considered in all respects as illustrative and not restrictive, the scope of the invention being indicated by the appended claims, rather than by the foregoing description, and all changes which come within the meaning and range of equivalency of the claims are intended to be embraced herein.

We claim:

1. A method of making a weak acid cation exchange resin comprising: converting a swollen form weak acid cation exchange resin to a converted, unswollen form weak acid cation exchange resin, and steam cleaning the converted, unswollen form weak acid cation ion exchange resin to obtain a cleaned weak acid cation exchange resin in an unswollen form.

2. The method of claim 1 in which the unswollen weak acid cation exchange resin is selected from one or more copolymers of crosslinked poly(acrylic acid), crosslinked poly(methacrylic acid), hydrolyzed crosslinked poly((C₁-C₄)alkyl acrylate) and hydrolyzed crosslinked poly(acrylonitrile).

3. The method of claim 1 in which the converted, unswollen, weak acid cation exchange resin is contacted with 2 to 5 kilograms of steam per kilogram of hydrogen-form weak acid cation exchange resin.

4. The method of claim 1 in which the converted, unswollen, weak acid cation exchange resin is contacted with steam for 2 to 4 hours.

5. The method of claim 1 in which the converted, unswollen weak acid cation exchange resin is contacted with a peroxide.

6. A resin made by the method of claim 1.

7. A system or product comprising the resin of claim 1.

8. The system or product of claim 7 in which said system is selected from the group consisting of a pharmaceutical purification system, an industrial water treatment system, a consumer water treatment system, and a catalytic system, and in which said product is selected from the group consisting of a water purification jug, a water purification cartridge, and combinated cartridge and jug.

9. A downstream product made using the resin of claim 1.

10. The downstream product of claim 9 selected from the group consisting of a pharmaceutical ingredient, a pharmaceutical excipient, a purified water, and a high purity water.
